(19) United States
(12) Patent Application Publication
(10) Pub. No.: US 2021/0214155 A1
(43) Pub. Date: Jul. 15, 2021

(54) Releasable Retention Device

(71) Applicant: Michael L. Hampton, Layton, UT (US)

(72) Inventor: Michael L. Hampton, Layton, UT (US)

(21) Appl. No.: 16/742,816

(22) Filed: Jan. 14, 2020

(51) Int. Cl. B65F 1/14; B65F 1/06

(52) U.S. Cl. CPC B65F 1/1415; B65F 2210/18; B65F 1/068

(57) ABSTRACT

A releasable retention device for retaining a bag with a container, especially a waste container. The releasable retention device has a cap and a hollow base with open ends. Flexible flaps attached to the cap near the perimeter of the cap on the side of the perimeter toward the center of the cap. When an agglomerated portion of a bag is pushed through the flexible flaps, the flexible flaps primarily frictionally. The flexibility of the flaps reduces the risk of tearing a bag. The hollow base is attached to the bottom of the cap and has on its outer surface a fastener for maintaining the releasable retention device within a container.

### BACKGROUND OF THE INVENTION

### Field of the Invention

This invention relates to devices for retaining bags within a container, especially a waste container.

### Description of the Related Art

A multitude of patents exist for retaining bags, usually plastic bags for holding waste, within waste containers which are rigid.

These bags are also termed flexible liners. As used herein the term bag is defined to include any flexible container for holding waste which can be inserted into a rigid waste container.

Such waste containers are essentially synonymously called waste baskets, waste receptacles, and garbage cans. Herein “waste container” is defined to mean all such devices for holding waste, trash, garbage, or the like.

Four patents which are notable but all use rigid or at least “semi-rigid” elements of the rigid waste container for contacting one or more portions of the bag to retain the bag within the rigid waste container.

U.S. Pat. No. 5,711,499 applies only to a bag 2 having handles 3. According to lines 5 through 17 in column 3 of that patent, “The recycling wastebasket 1, in addition, includes in each corner thereof a longitudinal slot 6 shown in greater detail in FIG. 5 to receive and retain the pair of handles 3 after the shopping bag 2 has been inserted in wastebasket 1. The handles 3 are disposed externally of the wastebasket 1 when received and retained in the four slots 6. The handles 3 are pulled downward into and engage the slots 6 with an outward tension applied to the bag 2 by the handles 3 causing the shopping bag 2 to be pulled taut so that the wall of the shopping bag 2 will bear against the inner wall of the basket with the handles 3 remaining outside the wastebasket 1. When the shopping bag 2 is full of waste, a pull upward on handles 3 will enable easy removal of the shopping bag 2.”

Three patents which have been assigned to Rubbermaid Commercial Products LLC also utilize rigid slots in a waste container to retain a bag but do not require the bag to have handles.

Lines 57 through 60 in column 2 of U.S. Pat. No. 8,807,381, provide, “The cinch 40 also includes a slot 52 having an open end 53 and a closed end 54. The slot 52 can be disposed within the projection 50 and configured such that at least a portion of the liner 24 can be disposed and retained within the slot 52.

Lines 59 in column 3 through line 5 in column 4 of that same patent continue, “In the embodiment shown in FIGS. 8-14, the liner 124 is inserted into the body 111 of the receptacle 110 and a portion of the liner 124 is disposed around the rim 137 of the body 111. The liner 124 is pulled so that it is taught around the rim 137. A portion of the liner 124 is twisted to form an area of increased width (see FIG. 14), and this twisted portion is placed between the projection 150 and the body 111 and pulled upwards into the slot 152. The slot 152 holds the bunched liner 124 via friction, such that the portion of the liner 124 will be retained within the slot 152. The retention of the liner 124 in the slot 152 is enhanced by the area of increased width formed by twisting the liner 124. The liner 124 is held such that it is taught around the rim 137 while remaining disposed within the body 111.”

Identical language is used in U.S. Pat. No. 9,079,711.

Similar language is also utilized in U.S. Pat. No. 10,273,081.

Lines 18 through 22 in column 5 of U.S. Pat. No. 10,273,081, state, “In the embodiment shown, the cinch 101 can further include a slot 109, which can extend from the outer surface 105b to the inner surface 105a of the first member 105. The slot 109 can further have an open end 111 and a closed end 113.”

Lines 25 through 28 in that patent, declare, “In certain embodiments, the cinch 101 may be composed of any acceptable material, including but not limited to, rigid or semi-rigid plastics, metals, or carbon fiber materials, which would be known to those of skill in the art.” There is, however, no suggestion of any flexibility; and such a characteristic would impair the operation of any of the four preceding patents.

Line 62 in column 6 through line 17 in column 7 of U.S. Pat. No. 10,273,081 further relate, “In some embodiments, a method of using a receptacle is provided. The method can include inserting a flexible liner 125 into a body 119 of the receptacle 117, pulling the flexible liner 125 taut around a rim of the body so as to create a bunched portion from resulting slack, disposing at least one portion of the bunched portion of the flexible liner 125 through the through-hole 115 in the second member 107 and between the slot 109 and the body 119 before disposing the at least one portion of the bunched portion of the flexible liner 125 within the slot 109, and disposing the at least one portion of the bunched portion of the flexible liner 125 between the two side edges of the slot 109 such that the at least one portion of the bunched portion of the flexible liner 125 is retained within the slot 109, as depicted in FIG. 3. In other embodiments, a method of using a receptacle may include inserting a flexible liner 125 into a body 119 of the receptacle 117, pulling the flexible liner 125 taut around a rim of the body so as to create a bunched portion from resulting slack, and disposing the at least one portion of the bunched portion of the flexible liner 125 between the two side edges of the slot 109 such that the at least one portion of the bunched portion of the flexible liner 125 is retained within the slot 109.”

And lines 4 through 7 in column 8 of U.S. Pat. No. 10,273,081 indicate, “The cinch 501 can further include a slot 509, which can extend from the outer surface 505b to the inner surface 505a of the first member 505. The slot 509 can have an open end 511 and a closed end 513.”

Additionally, another rigid device for releasably retaining a bag in a waste container is stated at a website which utilizes the url https://cdnimg.webstaurantstore.com/documents/podf/brocure/commercialzone_grabbag.pdg to be patented, although the inventor for the present invention was unable to located a United States patent for the device.

This device comprises and aperture in a waste container with a sharply pointed projection at the top of an aperture and a mating projection at the bottom of the aperture. This website states, “Tuck trash bag through slot and pull tight. Trash bag will become hooked on the grab bag system and stay in place.”

It appears to the present inventor, however, that this device would create a substantial risk of puncturing the bag thereby likely leading to a tear in the back—but almost certainly an undesirable hole which would weaken the bag.

### BRIEF SUMMARY OF THE INVENTION

The present invention primarily utilizes flexible flaps to retain a bag with a container, especially a waste container, thereby reducing the risk of puncturing and, possibly, tearing the bag.

The Releasable Retention Device for a bag within a container, especially a waste container, comprises a cap having a perimeter.

The first end of each of multiple flexible flaps, preferably six or eight flaps, is attached to the cap near the perimeter of the cap and toward the center of the cap.

Each flexible flap extends inward toward the center of the cap, with the second end of each flexible flap being nearer to the center of the cap than is the first end of the cap—and, preferably, reaching—the center of the cap. The closer sides of each two adjacent flexible flaps preferably touch each other but may have a space between them.

Attached to the bottom of the cap is the first end of a hollow base. The first end of the hollow base and the second end of the hollow base, which is farther from the cap than is the first end of the hollow base, are both open to facilitate movement of the first end of each flexible flap into the hollow base.

Connected to the outer surface of the hollow base is a fastener for attaching the Releasable Retention Device to a container, preferably a waster container.

Herein in regard to connecting or attaching the elements of the Releasable Retention Device to other elements of that Device the terms “connect” or “attach” are defined to include any means of holding the elements together which is known by one skilled in the art as well as integrally forming the associated elements.

### BRIEF DESCRIPTION OF THE SEVERAL VIEWS OF THE DRAWING

FIG. 1 is a perspective view of a container, specifically a waste container, with a removable lid wherein two Releasable Retention Devices have been inserted into the container.

FIG. 2 is an elevation view of a container, specifically a waste container, with a Releasable Retention Device inserted into the container.

FIG. 3 is a perspective view of a container, specifically a waste container, holding a bag which is being retained by the Releasable Retention Device.

FIG. 4 is a cross-sectional view of the Releasable Retention Device into which an agglomerated portion of a bag has been inserted, wherein the container with the Releasable Retention Device has been indented, or recessed, to facilitate insertion of the Releasable Retention Device without obstructing the placement of a lid onto the container and wherein the Releasable Retention Device is maintained in place with two snap-fit joint.

FIG. 5 is the same as FIG. 4 except that no bag has been inserted.

FIG. 6 is the same as FIG. 6 with the exception that the Releasable Retention Device is maintained in place with threads on the exterior of the base of the Releasable Retention Device being mated with threads on a releasable washer.

FIG. 7 is a plan view from the top for an embodiment of the Releasable Retention Device having six flaps.

FIG. 8 is a plan view from the top for an embodiment of the Releasable Retention Device having eight flaps.

### DETAILED DESCRIPTION OF THE INVENTION

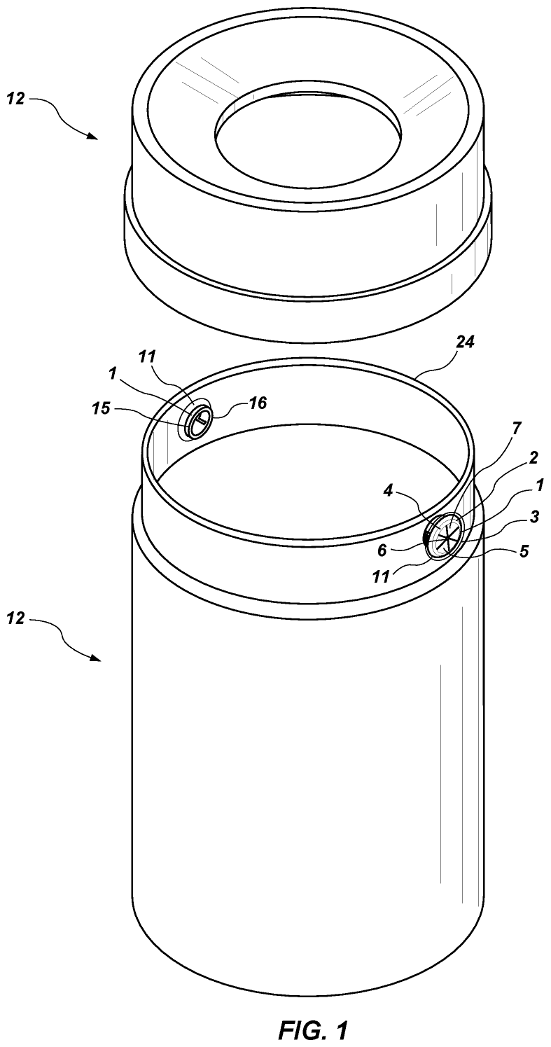

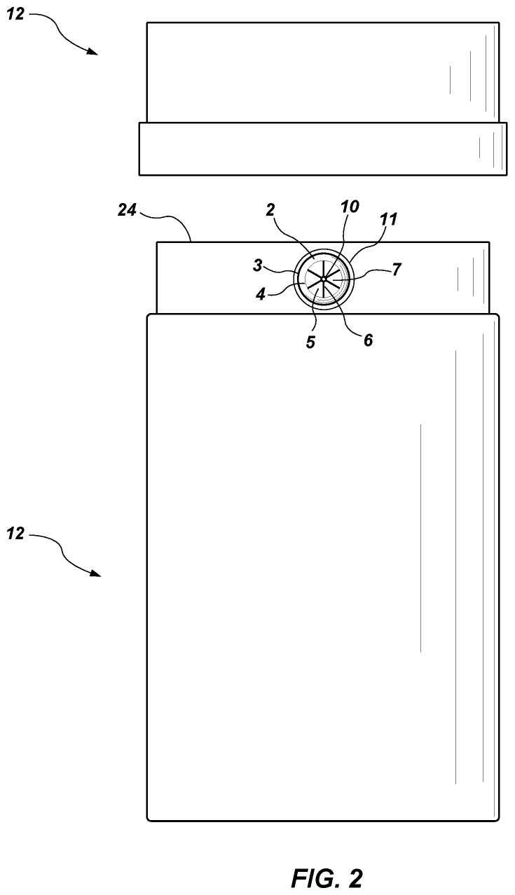

The Releasable Retention Device 1 for a bag within a container, especially a waste container, comprises a cap 2 having a perimeter 3, as illustrated in FIGS. 1 through 8.

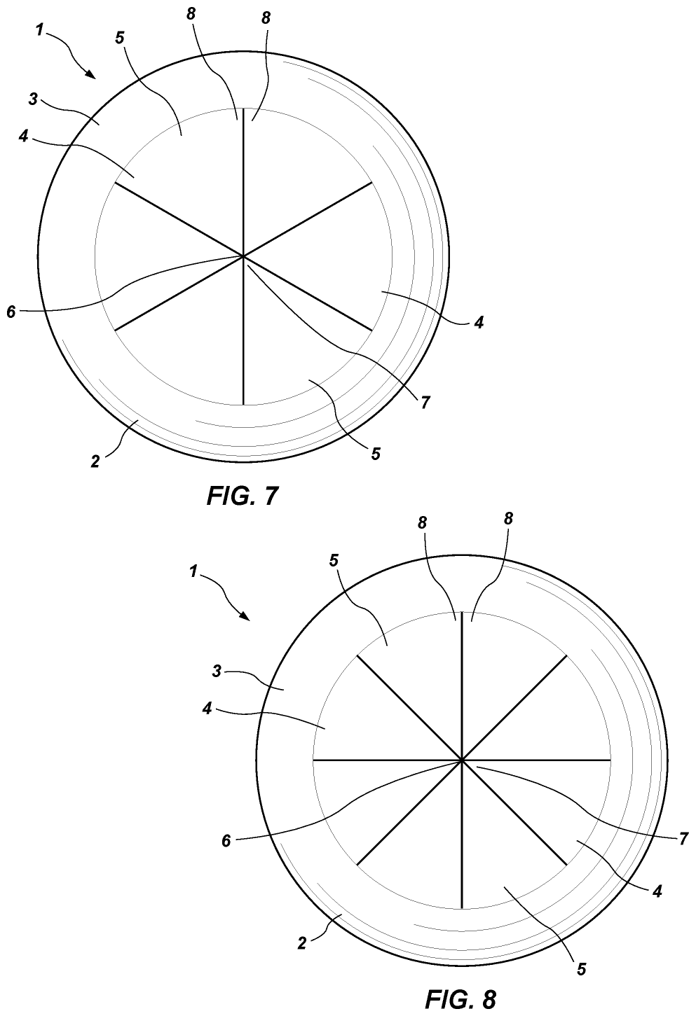

The first end 4 of each of the multiple flexible flaps 5, preferably six or eight flaps 5, is, as most clearly seen in FIGS. 7 and 8, attached to the cap 2 near the perimeter 3 of the cap 2 and toward the center 6 of the cap 2.

Each flexible flap 5 extends inward toward the center 6 of the cap 2, with the second end 7 of each flexible flap 5 being nearer to the center 6 of the cap 2 than is the first end 4 of the cap 2—and, preferably, as illustrated in FIGS. 7 and 8, reaching—the center 6 of the cap 2. The closer sides 8 of each two adjacent flexible flaps 5 preferably touch each other, as shown in FIGS. 7 and 8, but may optionally have a space between them.

Multiple flexible 5 flaps create greater friction as a principal method to retain an inserted bag 9, and flexibility of the flaps 5 reduces the risk of tearing and inserted bag 9, especially upon insertion of a bag 9 into the Releasable Retention Device 1 or removal bag from the Releasable Retention Device 1. Shortened flaps 5, as shown in FIGS. 1, 2, 5, and 6, however, do create a small aperture 10 in the center 6 of the cap 2 which somewhat eases the insertion and removal of a bag 9 into and from the Releasable Retention Device 1.

The cap 2 can have any cross-sectional shape as long as a sufficient portion of the cap 2 extends sufficiently far beyond the aperture 11 in the container 12 into which the Releasable Retention Device 1 is inserted to prevent the cap 2 from being pushed through the aperture 10, an amount of extension which one of ordinary skill in the art would know.

Attached to the bottom 13 of the cap 2, as portrayed in FIGS. 1, 4, 5, and 6, is the first end 14 of a hollow base 15. The first end 14 of the hollow base 15 and the second end 16 of the hollow base 15, which is farther from the cap 2 than is the first end 14 of the hollow base 15, are both open to facilitate movement of the first end 4 of each flexible flap 5 into the hollow base 15.

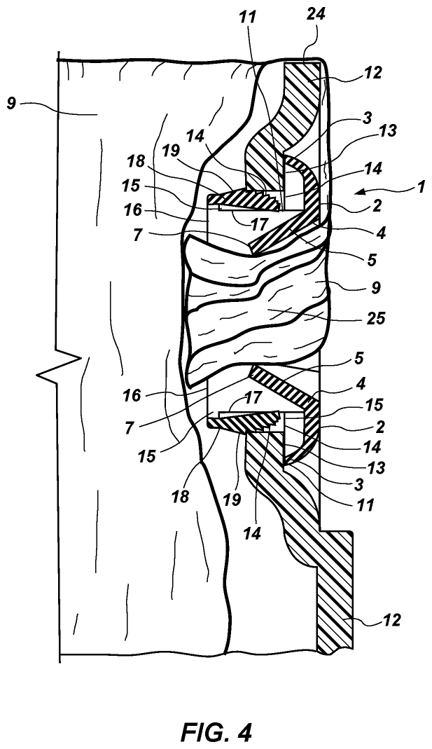

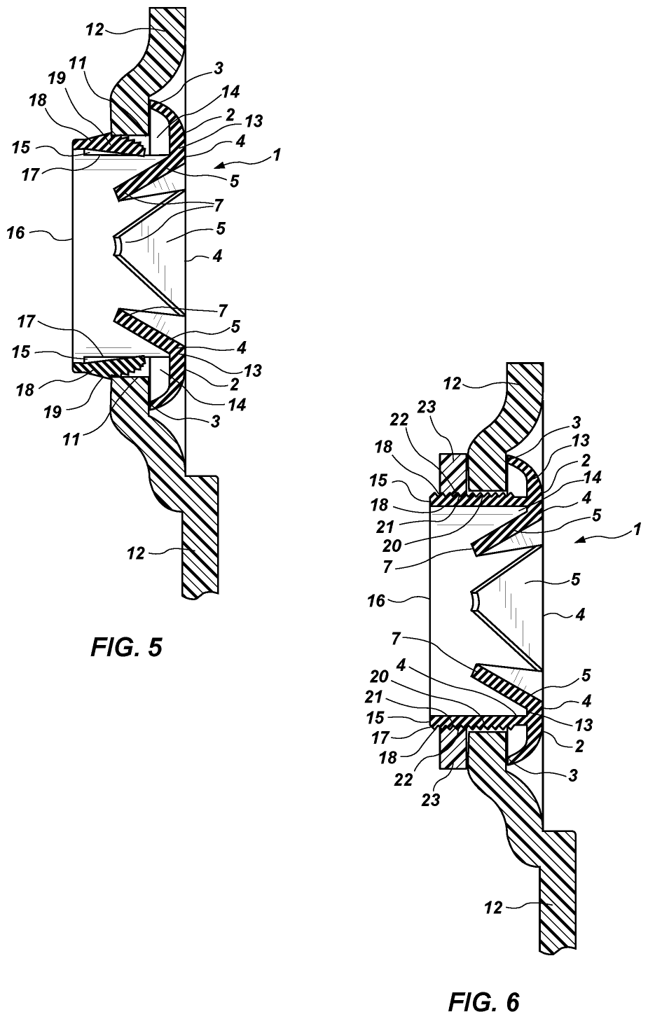

Connected to the outer surface 17 of the hollow base 15 is one or more fasteners 18 for attaching the Releasable Retention Device 1 to a container 12, preferably a waster container 12. The fastener 18 can be any fastener known to one of ordinary skill in the art. Suitable examples, though, are at least one snap-fit joint 19 and preferably two snap-fit joints, as illustrated in FIGS. 4 and 5, and threads 20 on the outer surface 17 of the hollow base 15 to mate with threads 21 on the inner surface 22 of a traditional retaining washer 23, as shown in FIG. 6. Alternatively, rather than using a retaining washer 23, mating threads can be, as one of ordinary skill in the art would know, on the sides of the aperture 11 in the container 12.

The cross-sectional shape of the hollow base 15 need not be circular if the hollow base 15 is attached to the container 12 with something other than threads 20, such as at least one snap-fit joint 19.

The Releasable Retention Device 1 can be constructed with any material known to one of ordinary skill in the art. Two suitable exemplary materials are, however, either polypropylene by itself or a combination of polypropylene with polyethylene.

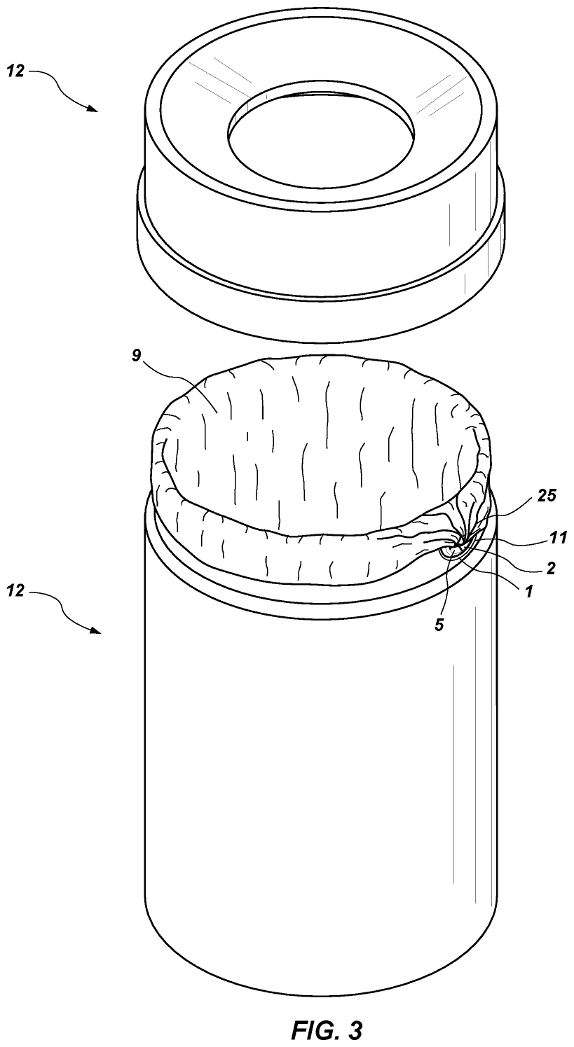

A method for utilizing the Releasable Retention Device 1 to retain a bag within a container, especially a water container, is as follows: The free end 23 of the bag 9 is, as illustrated in FIGS. 3 and 4, pulled upward and then outward and downward over the upper rim 24 of the container 12. The free end 23 of the bag 9 is then pulled tight around the upper rim 24 creating an agglomerated portion 25 of the bag 9 which agglomerated portion 25 is pushed through the flexible flaps 5 of the Releasable Retention Device 1 into the container 12. When desired, the agglomerated portion 25 of the bag 9 is pulled or pushed from the Releasable Retaining Device 1.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

I claim:

1. A releasable retention device, which comprises:
a cap having a perimeter, a center, and a bottom:
a multitude of flexible flaps, each of said flaps having a first end attached to said cap near the perimeter of said cap toward the center of said cap, each of said flexible flaps extending inward toward the center of said cap with a second end of each of said flexible flaps being nearer to the center of said cap than is the first end of each of said flaps, and each of said flaps having sides;
a hollow base having a first open end attached to the bottom of said cap, a second open end that is farther from said cap than is the first open end of said hollow base, and an outer surface; and
at least one fasteners attached to the outer surface of said hollow base.

2. The releasable retention device as recited in claim 1, wherein:
the second end of each of said flexible flaps reaches the center of said cap.

3. The releasable retention device as recited in claim 2, wherein:
the closer sides of each two adjacent flexible flaps touch each other.

4. The releasable retention device as recited in claim 3, wherein:
said fastener is a snap-fit joint.

5. The releasable retention device as recited in claim 3, further comprising:
threads on the outer surface of said hollow base.

6. The releasable retention device as recited in claim 5, further comprising:
a retaining washer having threads on its inner surface to mate with the thread of the outer surface of said hollow base.

7. The releasable retention device as recited in claim 2, wherein:
the closer sides of each two adjacent said flexible flaps have a space between each other.

8. The releasable retention device as recited in claim 7, wherein:
said fastener is a snap-fit joint.

9. The releasable retention device as recited in claim 7, further comprising:
threads on the outer surface of said hollow base.

10. The releasable retention device as recited in claim 9, further comprising:
a retaining washer having threads on its inner surface to mate with the thread of the outer surface of said hollow base.

11. The releasable retention device as recited in claim 1, wherein:
the second end of each of said flexible flaps does not reach the center of said cap.

12. The releasable retention device as recited in claim 11, wherein:
the closer sides of each two adjacent flexible flaps touch each other.

13. The releasable retention device as recited in claim 12, wherein:
said fastener is a snap-fit joint.

14. The releasable retention device as recited in claim 12, further comprising:
threads on the outer surface of said hollow base.

15. The releasable retention device as recited in claim 14, further comprising:
a retaining washer having threads on its inner surface to mate with the thread of the outer surface of said hollow base.

16. The releasable retention device as recited in claim 11, wherein:
the closer sides of each two adjacent said flexible flaps have a space between each other.

17. The releasable retention device as recited in claim 16, wherein:
said fastener is a snap-fit joint.

18. The releasable retention device as recited in claim 16, further comprising:
threads on the outer surface of said hollow base.

19. The releasable retention device as recited in claim 18, further comprising:
a retaining washer having threads on its inner surface to mate with the thread of the outer surface of said hollow base.
